(19) United States
(12) Patent Application Publication
(10) Pub. No.: US 2008/0127789 A1
(43) Pub. Date: Jun. 5, 2008

(54) Tailstock of woodturning lathe

(76) Inventor: Calvin Chou, Dah Li City (TW)

Correspondence Address: CHARLES E. BAXLEY, ESQ., 90 JOHN STREET, THIRD FLOOR, NEW YORK, NY, 10038, US

(21) Appl. No.: 11/634,457

(22) Filed: Dec. 5, 2006

(51) Int. Cl. B23B 23/00

(52) U.S. Cl. 82/148

(57) ABSTRACT

A tailstock of a woodturning lathe comprises: an axial block settled on the lathe bed which can be axially moved and positioned along the lathe bed, a radial block including a stationary seat fixedly fastened to the axial block and a sliding seat which can be moved and positioned against the stationary seat, a tailstock body fixedly fastened with the sliding seat, a first handwheel for controlling a first lead screw which is piercing through the tailstock body to rotate, wherein as the first lead screw is rotated, a linear movement of an edge case, spacer ring seat, spacer ring, second lead screw, shaft and workpiece fastener which are connectedly assembled can be conducted, and a second handwheel for controlling the shaft and a second lead screw to rotate, wherein as the second lead screw is rotated, the work piece fastener is propelled to perform a spiral movement in accordance with the threads of the second lead screw.

### BACKGROUND OF THE INVENTION

1. Technical Field

The present invention relates to woodturning lathes, and more particularly, to an improved tailstock of a woodturning lathe.

2. Description of Related Art

A conventional woodturning lathe typically includes a lathe bed whereon a headstock and a tailstock are aligned coaxially, and a carriage is arranged between the-headstock and tailstock.

In such a conventional woodturning lathe, a live center is settled on the headstock and a dead center is settled on the tailstock for cooperatively supporting a workpiece at its axis to facilitate processing operations against the workpiece such as turning, cutting, knurling or parting off by a tool assembled on the carriage. Alternatively, the tailstock can be assembled with a drilling tool to realize a central-hole drilling operation. However, according to foresaid structure, since the live center of the tailstock and the dead center of the headstock are aligned coaxially and the headstock is incompetent to provide some specific feed travels because it is immovably fixed on the lathe bed, such a conventional woodturning lathe is handicapped by not workable for threading, grooving an index plate, internal trimming or so forth.

### SUMMARY OF THE INVENTION

The present invention has been accomplished under the circumstances in view.

It is one object of the present invention to provide a tailstock that can be operated to move along the X and Y axes of the lathe. When moving along the Y axis, the tailstock performs significant displacement relative to the headstock; while moving along the X axis, the tailstock can bring the live center thereof to positions aligned with or divergent from the axis of the dead head of the headstock.

It is another object of the present invention to provide a tailstock that comprises an edge case whereon a tool, a center, a workpiece fastener or the like can be mounted.

It is still another object of the present invention to provide a tailstock that can provide a special feed travel for spiral milling and thereby a woodturning lathe can perform external threading and internal threading operation.

To achieve these and other objects of the present invention, the tailstock of a woodturning lathe comprises: an axial block settled on the lathe bed which can be axially moved and positioned along the lathe bed, a radial block including a stationary seat fixedly fastened to the axial block and a sliding seat which can be moved and positioned against the stationary seat, a tailstock body fixedly fastened with the sliding seat, a first handwheel for controlling a first lead screw which is piercing through the tailstock body to rotate, wherein as the first lead screw is rotated, a linear movement of the edge case, spacer ring seat, spacer ring, second lead screw, shaft and work piece fastener which are connectedly assembled can be conducted, and a second handwheel for controlling the shaft and a second lead screw to rotate, wherein as the second lead screw is rotated, the workpiece fastener is propelled to perform a spiral movement in accordance with the threads of the second lead screw.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of a woodturning lathe according to the present invention;

FIG. 2 is an exploded view of the tailstock of the woodturning lathe of the present invention;

FIG. 3 is an assembly drawing of the tailstock of the present invention;

FIG. 4 is a partial schematic cross sectional view taken along the direction of Arrow 4 in FIG. 3 showing the internal structure of the radial block, axial block and lathe bed;

FIG. 5 is according to FIG. 4, showing the axial block fixed to the lathe bed;

FIG. 6 is an exploded view of the tailstock body of the present invention;

FIG. 7 is a sectional view of the tailstock body of the present invention;

FIG. 8 is an applied view illustrating the operation of the first handwheel;

FIG. 9 is an applied view illustrating the operation of the second handwheel; and

FIG. 10 is an applied view showing a tool assembled to the tailstock body at the edge case.

### DETAILED DESCRIPTION OF THE PREFERRED EMBODIMENT

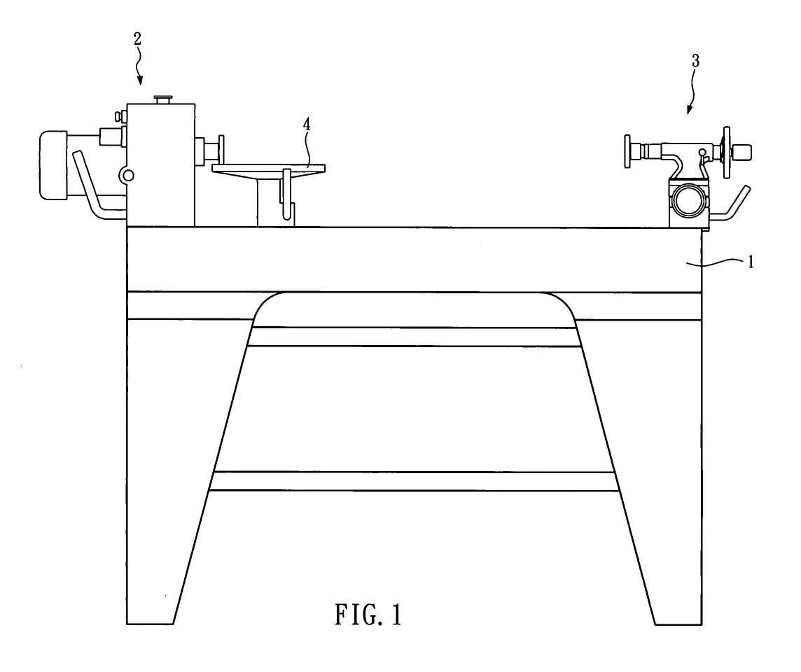

FIG. 1 is provided for illustrating a woodturning lathe which primarily comprises a lathe bed 1 whereon a headstock 2 and a tailstock 3 are aligned coaxially and a carriage 4 is provided for carrying a tool-support and a tool thereon.

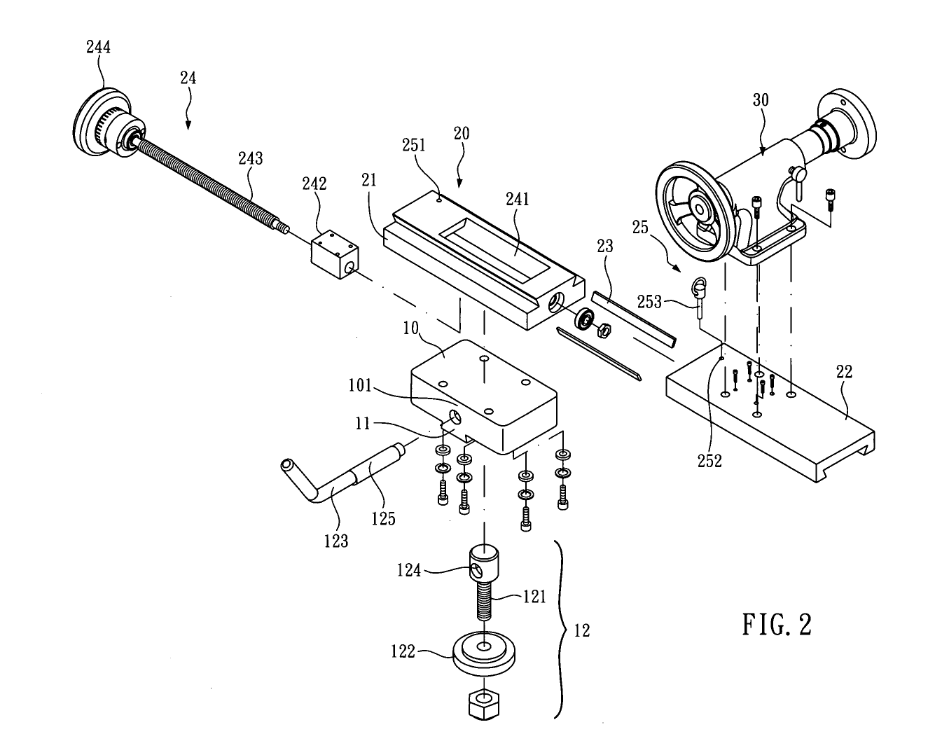

As can be seen in the FIGS. 2 to 5, the presently disclosed tailstock includes an axial block 10, a radial block 20, and a tailstock body 30.

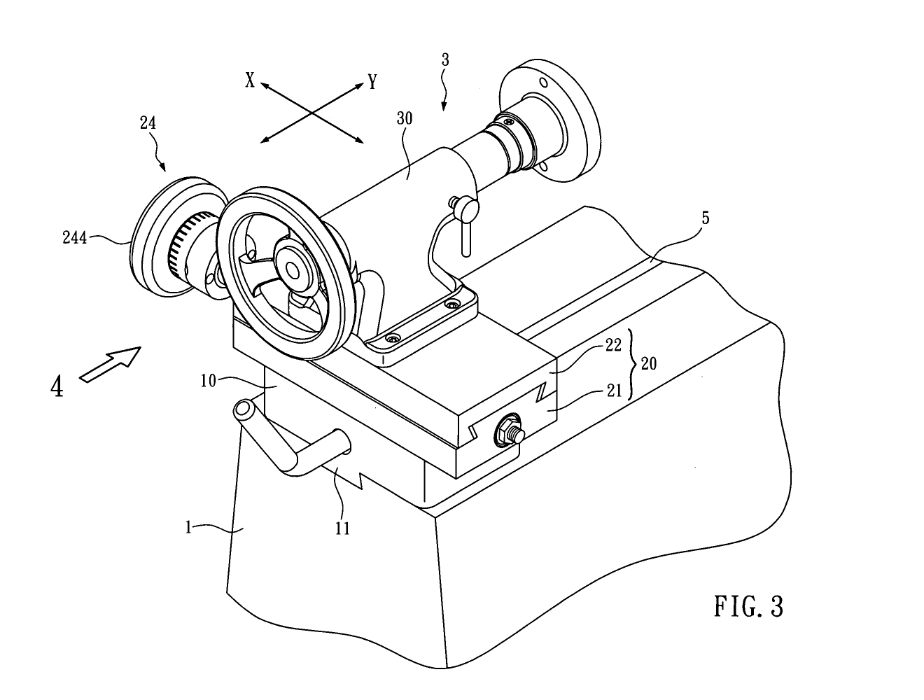

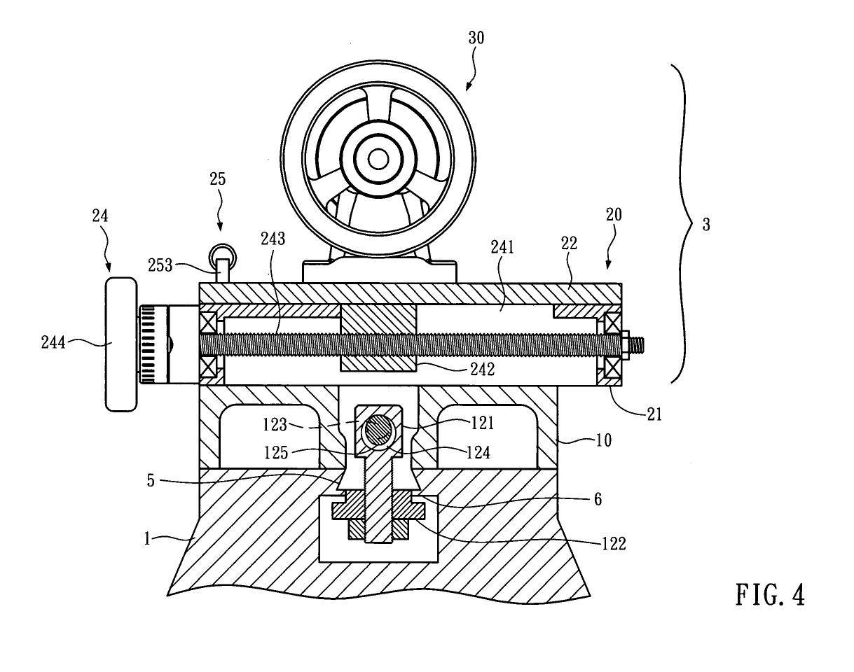

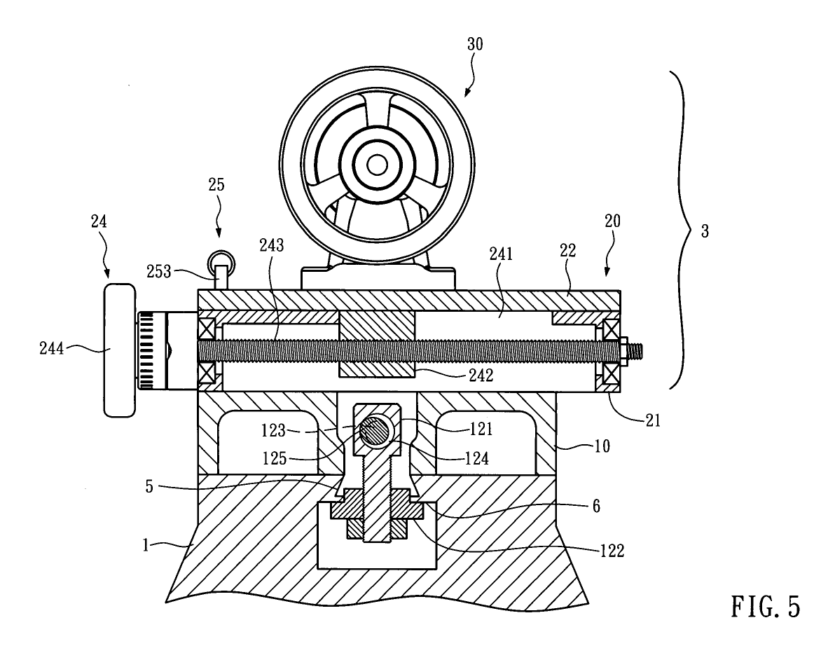

Further, the axial block 10 has a positioning key 11 extended from the bottom thereof slidably combined with a recessed runner 5 provided on the lathe bed 1. Between the axial block 10 and lathe bed 1, a positioning assembly 12 is further provided which contains a movable positioning rod 121 provided vertically through the axial block 10 and a lever 123 for operating the positioning rod 121 to move vertically wherein the lever 123 is passing horizontally through the axial block 10 and the head portion of the positioning rod 121 while the threaded bottom portion of the positioning rod 121 is extending into the lathe bed 1 and secured with a positioning plate 122. Meantime, the head portion of the positioning rod 121 includes a radial round-sectioned lever hole 124 for accommodating an elliptic-sectioned combining portion 125 of said lever 123. Thus, when the lever 123 is pulled, the elliptic-sectioned combining portion 125 thereof can rotate eccentrically to vertically shift the positioning rod 121 to a small extent. According to FIG. 4, when the positioning rod 121 is lowered, the positioning plate 122 is moved off from contacting with a ceiling of lathe bed 6 so that the axial block 10 is allowed moving along a Y axis as shown in FIG. 3 with the positioning key 11 sliding in the runner 5. Referring to FIG. 5, as the positioning rod 121 is lifted, the positioning plate 122 again comes into closely adjacent to the ceiling of lathe bed 6, and the axial block 10 is thereby immovably fixed.

Moreover, the radial block 20 comprises a stationary seat 21 and a sliding seat 22 wherein the stationary seat 21 is fixedly mounted on the top of the axial block 10; slidably combined with the sliding seat 22 by means of a sliding rail structure 23; and the sliding seat 22 is with the top surface fixedly attached to the tailstock body 30. Further, said sliding seat 22 can be operated to slide against the stationary seat 21 by means of an adjuster 24 which comprises a through hole 241 provided on the stationary seat 21, a displacement component 242 positioned in the through hole 241 and fixed to the sliding seat 22, a lead screw 243 rotatably arranged through the stationary seat 21 and held by the displacement component 242 by thread means, and an adjusting wheel 244 fixed at one end of the lead screw 243. Thereby, through the adjusting wheel 244 the displacement component 242 can be operated to linearly move within the through hole 241, and therefore the siding seat 22 can be pushed to move along an X axis as depicted in FIG. 3.

Furthermore, an axle alignment apparatus 25 is provided about the stationary seat 21 and sliding seat 22 for facilitating promptly aligning the axle centers of the tailstock body 30 and headstock 2. Said axle alignment apparatus 25 comprises a first positioning hole 251 provided on the stationary seat 21, a second positioning hole 252 provided on the sliding seat 22 and a pin 253 for being lodged successively into said positioning holes 251, 252. When the positioning holes 251, 252 are vertically aligned, it signifies that the axle centers of the tailstock body 30 and headstock 2 are aligned mutually coaxially. At this point, the stationary seat 21 and sliding seat 22 can be secured at the aligned position by the pin 253 lodged therein.

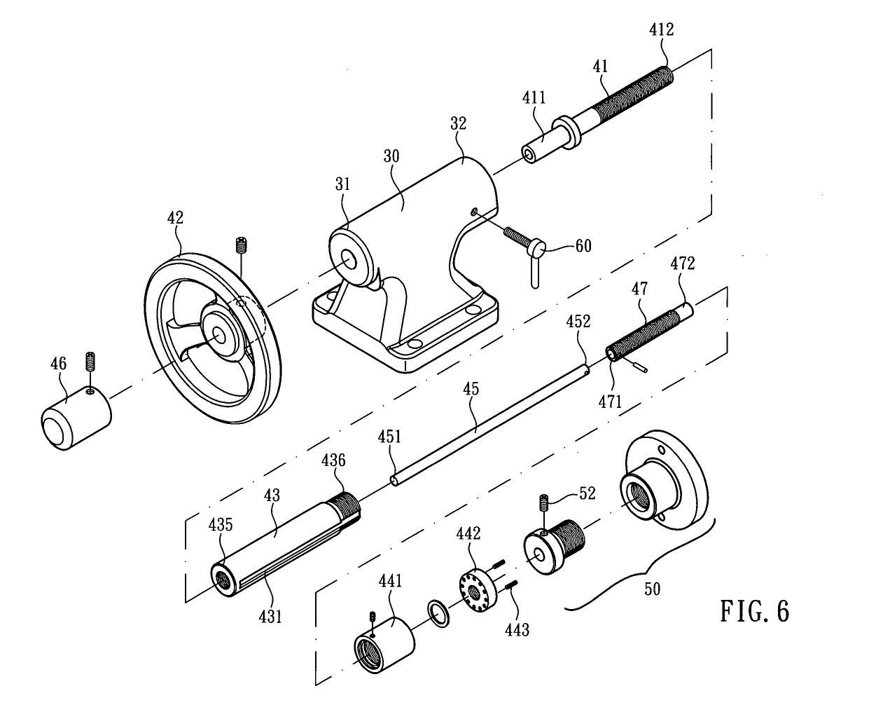

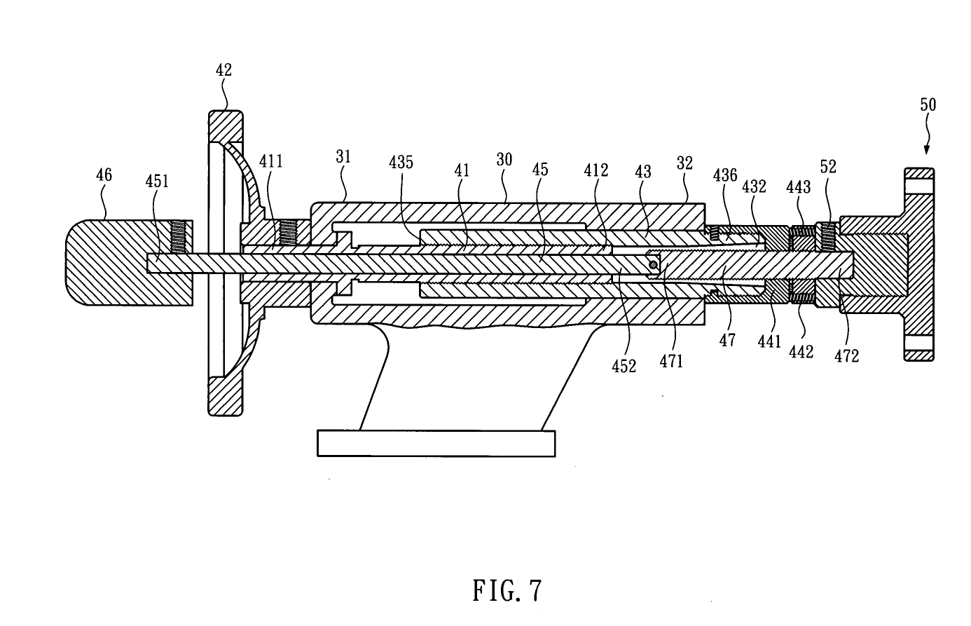

In FIGS. 6 and 7, it can be seen that inside the tailstock body 30, a first lead screw 41 is provided which has a first end 411 jutting out of a first end 31 of the tailstock body 30 and fixedly fastened to a first handwheel 42; and a second end 412 coupled with a first end 435 of an edge case 43 by thread means wherein said edge case 43 comprises an axial keyway 431 extending axially on the surface thereof for being positioned within the axial block 10 from rotating, and a second end 436 which is jutting out of a second end 32 of the tailstock body 30 having a tool socket 432 and a plurality of external threads therearound.

Further, a shaft 45 is pierced through the first lead screw 41 with a first end 451 thereof jutting out of the first end 31 of the tailstock body 30 and the first handwheel 42 to be fixed to a second handwheel 46, and with a second end 452 jutting out of the first lead screw 41 to be fixed with a first end 471 of a second lead screw 47.

Moreover, the second end 436 of the edge case 43 is coupled with a spacer ring seat 441 by the external threads thereof and the second end 472 of the second lead screw 47 is jutting out of the pacer ring seat 441 to be connected with a spacer ring 442, which is positioned at the extremity of the pacer ring seat 441 by means of a plurality of fasteners 443, and to be further fastened with a workpiece fastener 50 via a fastening component 52 for carrying a tool (not shown).

Furthermore, an edge case positioner 60 is provided radially in the tailstock body 30 which can be pushed inward the tailstock body 30 to press tightly the edge case 43 so that the tailstock body 30 can be retained at a preset position from leaving.

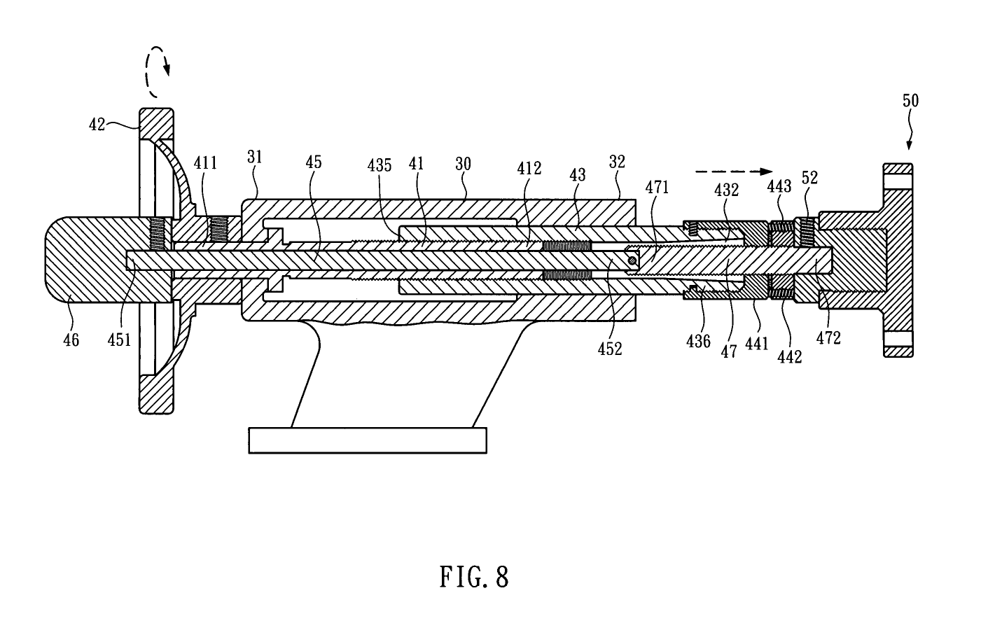

According to FIG. 8, when preparing for normal wood processing operation, a workpiece (not shown) is fixed at the workpiece fastener 50 and a tool is installed on the headstock 2 (not shown). Then the first handwheel 42 is rotated along a predetermined direction to connectedly rotate the first lead screw 41 so that the edge case 43, spacer ring seat 441, spacer ring 442, second lead screw 47, shaft 45, workpiece fastener 50 and the workpiece installed thereon (not shown) can realize a linear travel. Thereby, the cutting operation can be accomplished under the relative motion of said tool and workpiece.

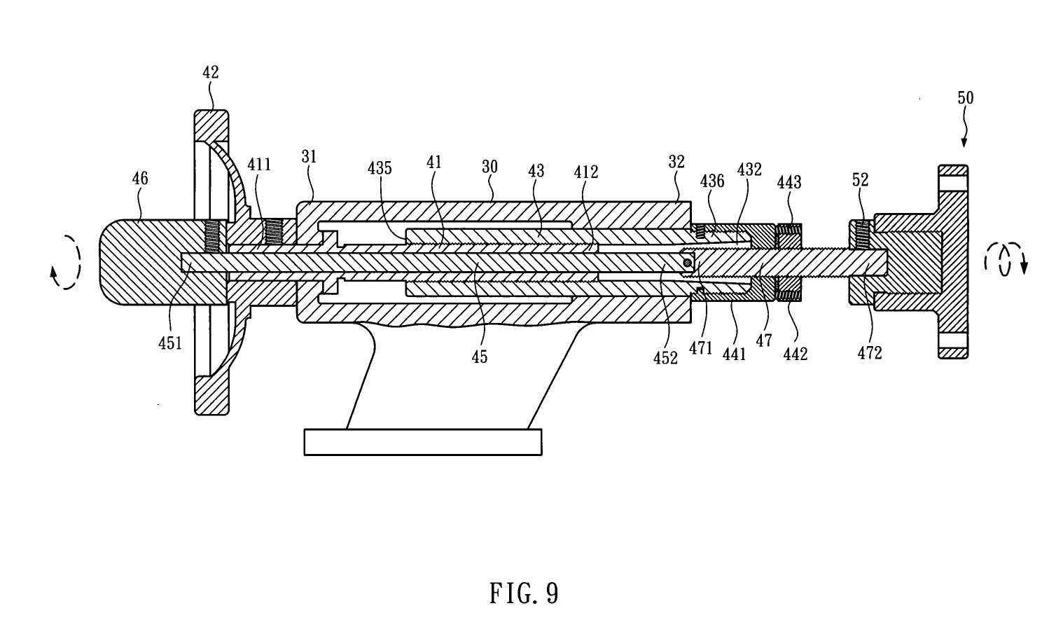

According to FIG. 9, when preparing for thread processing operation, the edge case positioner 60 (shown in FIG. 1) is screwed inward the tailstock body 30 to make the edge case 43, first lead screw 41, first handwheel 42, spacer ring seat 441 and spacer ring 442 tightly combined. Then the second handwheel 46 is rotated along a predetermined direction to connectedly rotate the shaft 45 and second lead screw 47 so that since the second lead screw 47 is in mesh with the spacer ring 442, the workpiece fastener 50 can be pushed to perform a spiral travel.

Successively, if said radial block 20 is pushed to move along the X axis, the center of the tailstock body 30 can be positioned divergently from the axle of the headstock 2. Thus, by the co-ordination between the operation of the tool installed on the headstock 2 and spiral travel of the workpiece fastened on the tailstock 3, the woodturning lathe can realize the thread processing operation such as internal threading or external threading.

As to foresaid thread processing operation, when the workpiece to be processed is propelled spirally in accordance with the threads of the second lead screw 47, a threading tool equipped on the headstock 2 can make threads on the workpiece corresponding to those of the second lead screw 47. In other words, it is possible for the lathe to make different types of threads by implementing diverse second lead screws 47 with different types of threads.

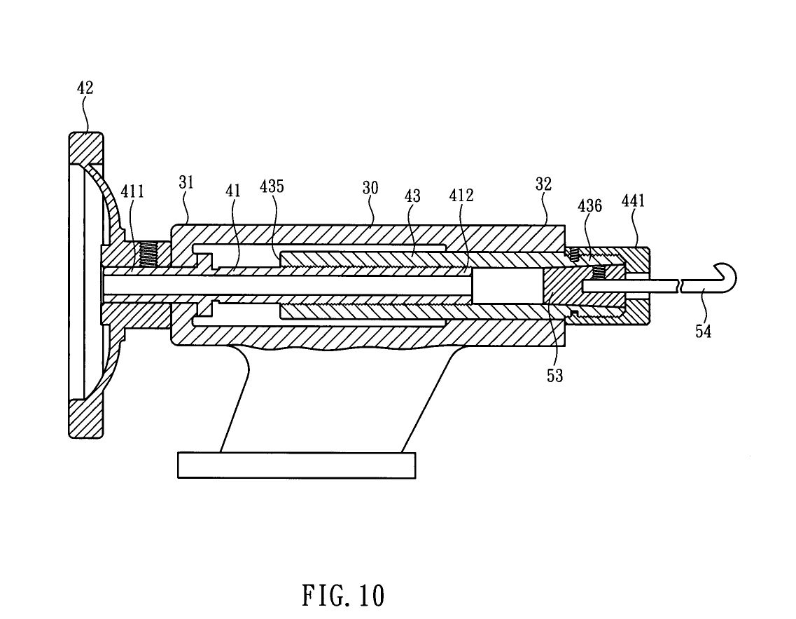

As shown in FIG. 10, mentioned spacer ring 442, shaft 45, second handwheel 46, and second lead screw 47 are detachably assembled to the tailstock body 30 for thread processing operation and can be removed when the lathe is subject to alternative processing operations other than thread processing. As the spacer ring 442, shaft 45, second handwheel 46, and second lead screw 47 are disassembled from the tailstock body 30, the edge case 43 can be loaded with a tool, a center, a clamping chuck, a workpiece fastener or an index plate at the tool socket 432 to meet the needs of varied progressing operations. Thus, according to FIG. 10, a tool seat 53 is inserted in the tool socket 432 of edge case 43 to immovably receive a tool 54 while a workpiece is rotatably fixed on the headstock 2 by means of a clamping chuck. Thereby, the tool can be displaced along X and Y axes under operation of the axial block 10 and radial block 20 and can be moved linearly under operation of the first handwheel 42 to process the workpiece for internal trimming or external cutting. Alternatively, if an index plate is mounted on the clamping chuck, the lathe can also perform grooving operation for the index plate.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A tailstock of a woodturning lathe, which has a lathe bed whereon a headstock, a tailstock and a carriage for carrying a tool-support and a tool are assembled, comprises:
an axial block settled on the lathe bed which can be moved and positioned against the lathe bed,
a radial block including a stationary seat fixedly fastened to the axial block and a sliding seat which can be moved and positioned against the stationary seat,
a tailstock body fixedly fastened with the sliding seat of the radial block,
a first lead screw which is pierced through the tailstock body with a first end thereof jutting out of the tailstock body and fixedly fastened to a first handwheel,
an edge case with a first end thereof connected with a second end of the first lead screw which is limited from rotating within the tailstock,
a shaft pierced through the first lead screw which as a first end jutting out of the tailstock body and the first handwheel to be further connected to a second handwheel and a second end fixedly fasten to a second lead screw,
a spacer ring seat fixedly encompassing a second end of the edge case, and
a spacer ring fastened at the extremity of the pacer ring seat and having a plurality of internal threads for meshing the second lead screw.

2. The tailstock as claimed in claim 1, wherein an edge case positioner is provided radially in the tailstock body which can be pushed inward the tailstock body to press the edge case tightly.

3. The tail stock as claimed in claim 1, wherein a tool socket is provided at the center of the second end of the edge case.

4. The tailstock as claimed in claim 1, wherein the second end of the edge case is coupled with the spacer ring seat with a plurality of external threads thereof.

5. The tailstock as claimed in claim 1, wherein a positioning assembly is provided between the axial block and lathe bed for operating the axial block to be released from or positioned against the lathe bed.

6. The tailstock as claimed in claim 5, wherein the positioning assembly contains a movable positioning rod provided vertically through the axial block which has a head portion thereof located in the axial block and a bottom portion of the extending into the lathe bed and fixed with a positioning plate wherein the head portion of the positioning rod is connected to a lever for operating the positioning rod to move vertically.

7. The tailstock as claimed in claim 6, wherein the head portion of the positioning rod includes a radial round-sectioned lever hole for accommodating an elliptic-sectioned combining portion of said lever.

8. The tailstock as claimed in claim 1, wherein the axial block has a positioning key extended from the bottom thereof slidably combined with a recessed runner provided on the lathe bed.

9. The tailstock as claimed in claim 1, wherein the moving direction of the sliding seat is perpendicular to the moving direction of the axial block.

10. The tailstock as claimed in claim 9, wherein said sliding seat can be operated to slide or position against the stationary seat under the control of an adjuster.

11. The tailstock as claimed in claim 10, wherein the adjuster comprises a through hole provided on the stationary seat, a displacement component positioned in the through hole and fixed to the sliding seat, a lead screw rotatably arranged through the stationary seat and held by the displacement component by thread means, and an adjusting wheel fixed at one end of the lead screw.

12. The tailstock as claimed in claim 1, wherein an axle alignment apparatus is provided about the stationary seat and the sliding seat.

13. The tailstock as claimed in claim 12, wherein the axle alignment apparatus comprises a first positioning hole provided on the stationary seat, a second positioning hole provided on the sliding seat and a pin for being lodged successively into said positioning holes.

14. The tailstock as claimed in claim 1, wherein a workpiece fastener is fixedly fastened to a second end of the second lead screw.
